(19) United States
(12) Patent Application Publication
(10) Pub. No.: US 2010/0168914 A1
(43) Pub. Date: Jul. 1, 2010

(54) DIAGNOSIS AND MANAGEMENT SERVER FOR MULTI-KINDS ROBOTS

(75) Inventors: Taegun KANG, Daejeon-city (KR); Hyoungsun Kim, Daejeon-city (KR); Hyun Kim, Daejeon-city (KR); Kangwoo Lee, Daejeon-city (KR); Youngho Suh, Gwangju (KR); Joonmyun Cho, Daejeon-city (KR); Myungeun Kim, Daejeon-city (KR); Namshik Park, Daejeon-city (KR); Incheol Jeong, Daejeon-city (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon (KR)

(21) Appl. No.: 12/632,036

(22) Filed: Dec. 7, 2009

(30) Foreign Application Priority Data
Dec. 29, 2008 (KR) 10-2008-0135419
Sep. 24, 2009 (KR) 10-2009-0090563

(51) Int. Cl. G05B 19/418

(52) U.S. Cl. 700/248

(57) ABSTRACT

Provided proposes a structure of a robot management server and an internal structure of a robot that can interwork with an external server providing functions such as voice recognition, voice synthesis, image recognition, speaker recognition, gesture recognition, etc., and provide the corresponding functions as basic functions of the robot. Through the structure, the same interface, which accesses the internal structure of the robot, can be provided and the robot developer can develop applications handling multi-kinds robots and applications without being limited by the basic functions of the robot, by using the interface. In addition, malfunction and failure, which can occur during the operation of the robot, are checked by diagnosing, such that applications capable of appropriately processing the malfunction and failure can be developed.

### RELATED APPLICATIONS

The present application claims priority to Korean Patent Application Serial Number 10-2008-0135419, filed on Dec. 29, 2008 and Korean Patent Application Serial Number 10-2009-0090563, filed on Sep. 24, 2009, the entirety of which are hereby incorporated by reference.

### BACKGROUND OF THE INVENTION

1. Field of the Invention

The present invention relates to a remote diagnosis and management server for multi-kinds robots and a method thereof. More specifically, the present invention relates to a remote diagnosis and management server for multi-kinds robots and a method thereof capable of determining failure or not of a robot by diagnosing multi-kinds robots and taking measures against any possible failure.

2. Description of the Related Art

A robot has typically been based on an industrial robot technology. The industrial robot technology has widely been used for industrial fields associated with electronic, machine, computer H/W, etc., such as a motor, a decelerator, sensor, etc., which has contributed to activating an industry such as the above mentioned and achieving technical innovation. In addition, robots for special purposes such as military, research and development, etc., are continuously being developed and used. A next-generation robot is based on an intelligent service robot technology. The intelligent service robot technology is expected to help increase mobile capacity and innovate intelligence technology in existing computers and various information devices, including create and rapidly grow a new robot market. Until now, it cannot be said that a market for the intelligent robot has been created. However, the market is expected to reach about 4000 trillion dollar in 2020 (source: IFR material, Mitsubishi Research Institute, Inc., Japan Manufacturers' Association material). The intelligent service robot is a robot that understands human emotions and responds thereto by the interaction with a human being and provides various services to a human based on an information communication technology. The intelligent service robot means a robot that recognizes the external environment and judges situations by itself in order to autonomously perform operations. For example, the intelligent service robot can be classified into an industrial robot that is used for automobile, electronic products, semiconductor, biomedical preparation, agriculture, construction, work under water, work under an extremely dangerous environment, etc., and a service robot that is used for housework, education, cleaning, security, delivery, pet, games, medical treatment, nursing, etc.

As described above, the robot technology that has been recently developed is widely being used in a robot. As a result, the robot can do more functions and different kinds of robots can provide various functions.

Meanwhile, the one of the above mentioned various kinds of robots is the independent type robots. These robots have three function elements that sense external environment, process the external environment based on the sensed condition information, and take action as a result of the processed results.

However, the existing independent type robots recognize the environment only by using an infrared sensor, a camera sensor, an ultrasonic wave sensor, an accelerator sensor, etc., included in the robot, such that they have a limitation in recognizing the conditions and the existing independent type robots use only a processor included therein, such that they have a limitation in processing capacity.

As a result, a network-based robot, which can distribute and process the foregoing functions (sensing, processing, action) processed in the robot, has been introduced.

An object of the network-based robot is to overcome limitations such as condition recognition and processing, which are problems in the existing robots, and to provide various services, by using an external sensing function and an external processing function through the network. In other words, the robot having benefits in terms of price and performance can be implemented by using a sensor function included in the external environment such as a robot server rather than by increasing the sensing function of the robot and by using a high functional server at a remote place, for example, where the robot server is located, rather than by increasing the processing function of the robot. In other words, the network-based robot can provide the main service functions of the robot through the external server and simplify a robot hardware configuration, such that a robot that is relatively inexpensive and has excellent performance can be produced.

Currently, the more the robot is widely used the more the robot technology is developed. As a result, the robot requires more functions and various kinds of robots providing various functions of the robot are variously manufactured. Meanwhile, each manufacture can differently manufacture robots having various functions and an internal platform and its structure capable of realizing the functions. As a result, a robot unified S/W platform initiative (RUPI) standard is made in order to overcome the difference and operate a plurality of multi-kinds robots.

### SUMMARY OF THE INVENTION

The present invention proposes to solve the above problems.

The present invention relates to a lightweight robot that has a function capable of travelling without colliding with objects by using a sensor device such as ultrasonic wave, infrared ray, etc., and has minimum functions such as voice recording, voice reproduction, image recording, etc., through devices such as a camera, a display, a mike, a speaker, etc. Further, the present invention proposes a structure of a robot management server and an internal structure of a robot that can compatibly work with an external server providing functions such as voice recognition, voice synthesis, image recognition, speaker recognition, gesture recognition, etc., and provide the corresponding functions as basic functions of the robot. Through the structure, the same interface, which accesses the internal structure of the robot, can be provided and the robot developer can develop applications handling multi-kinds robots and applications without being limited by the basic functions of the robot, by using the interface. In addition, malfunction and failure, which can occur during the operation of the robot, are checked by diagnosing the robot, such that applications capable of appropriately processing any malfunction and failure can be developed.

The present invention provides a robot management server connected to a plurality of robots by a network, the robot management server comprising: a robot manager that generates or deletes virtual robot servers; a management function module that performs at least one of connection management, authentication, diagnosis, and profiling on the connected robots; the virtual robot servers that are generated by the robot manager and the number of the virtual robot servers generated equal to the number of kinds of connected robots; and virtual robot objects that are generated by the number of connected robots and each connected to the virtual robot servers corresponding to the kinds of robot of the virtual robot objects.

The robot manager, when a new robot is connected, determines whether there is a virtual robot server corresponding to the kind of newly connected robot among the generated virtual robot servers; if it is determined that there is the corresponding virtual robot server, generates a virtual robot object for the newly connected robot and connects it to the corresponding virtual robot server; and if it is determined that there is no corresponding virtual robot server, generates the virtual robot object for the newly connected robot and the virtual robot server for the kind of newly connected robot, and connects the virtual robot object to the virtual robot server.

The virtual robot server generates the virtual robot objects when the robot is connected and deletes the virtual robot objects when the robot is disconnected.

The virtual robot object includes at least one virtual component for accessing the functions of the robot.

The virtual robot object includes at least one virtual component that can perform additional functions in addition to functions installed in the robot.

The robot management server can be connected to the external server and the external server provides the robot function.

The robot management server receives diagnosis results of a state diagnosis module that is included in the robot diagnosing malfunction or failure of the robot.

The receiving data of the robot management server can be queried through a terminal connected to the network.

The robot is standardized by an RUPI standard.

The robot management server is connected to the robot in a wired or wireless scheme.

The present invention has the following effects.

In order to simultaneously operate the multi-kinds robots, the standardization of the communication schemes, the standardization of the connection control and authentication schemes, and the support of different functions for each robot, the support of functions capable of supplementing the function limitation of the robot, etc., are needed. In addition, in order to stably operate the robot, a function capable of detecting failures occurring in the robot and collecting and analyzing the failures is needed. The robot management server and the robot structure proposed in the present invention can overcome the function limitation of the multi-kinds robots and simultaneously manage the plurality of robots in one server. Further, the present invention provides a structure that can determine failure or not of the robot by diagnosing and taking measures against the failure, making it possible to more effectively operate the plurality of robots.

### BRIEF DESCRIPTION OF THE DRAWINGS

FIG. 1 is a diagram showing a configuration of a remote management system of a robot, in particular, a diagram showing a robot management server, a robot, and a robot middleware server (OPRoS);

FIG. 2 is a diagram showing a module configuration for each function of a robot according to the present invention, in particular, a diagram showing a configuration viewed from a functional viewpoint of a module in a robot for a diagnosis agent;

FIG. 3 is a diagram showing a hierarchical module configuration of a robot according to the present invention, in particular, a diagram showing a configuration of a module in a robot viewed from a hierarchical viewpoint;

FIG. 4 is a diagram showing a module of a robot management server according to a first embodiment of the present invention, in particular, a diagram showing a virtual module and a sharing module that are generated and managed when robots are actually connected to a robot management server;

FIG. 5 is a diagram showing a configuration of a robot and a robot management server according to a second embodiment of the present invention;

FIG. 6 is a diagram showing a configuration of a robot, a robot management server, and an external server according to a third embodiment of the present invention;

FIG. 7 is a diagram showing a structure of a robot resource diagnosis according to a fourth embodiment of the present invention, in particular, a diagram showing a structure of a module used for querying a system resource in a robot; and

FIG. 8 is a flowchart showing a process of connecting and disconnecting the robot to and from the robot management server according to the present invention.

### DETAILED DESCRIPTION OF THE PREFERRED EMBODIMENTS

The present invention will be described below with reference to the accompanying drawings. Herein, the detailed description of a related known function or configuration that may make the purpose of the present invention unnecessarily ambiguous in describing the present invention will be omitted. Exemplary embodiments of the present invention are provided so that those skilled in the art may more completely understand the present invention. Accordingly, the shape, the size, etc., of elements in the drawings may be exaggerated for explicit comprehension.

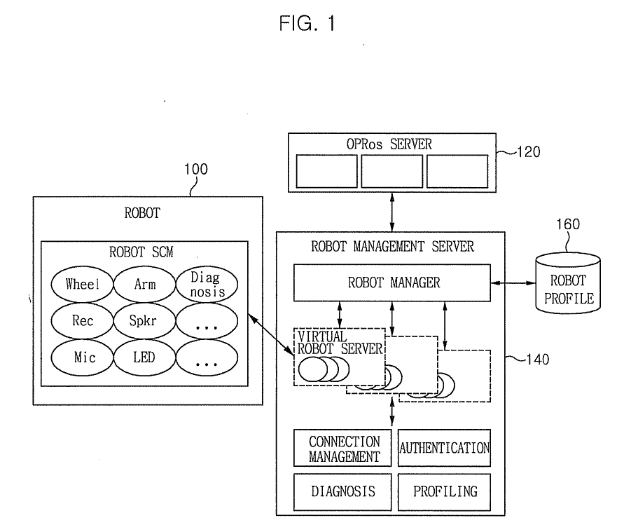

Referring to FIG. 1, a remote diagnosis and management system of a robot according to the present invention is configured to include a robot 100 and a robot management server 140. The robot management server 140 and the robot 100 can be connected to each other in a wired or wireless scheme through a network and a plurality of robots can be connected to the robot management server. Herein, the robot may be a machine apparatus having a human appearance and other various appearances, which includes machine and electronic apparatuses and can be controlled, may be considered to be a robot. The remote diagnosis and management system of a robot may include an OPRoS server 120. The OPRoS server 120 may be an external server connected to the robot management server 140 and may be collectively referred to as a server that is unified and operated with the robot management server 140. Meanwhile, the data from the robot management server 140 may be stored in an external database and may be connected to the external terminal to read the contents of the database.

In order for the system to simultaneously operate multi-kinds robots, the standardization of the communication schemes, the standardization of the connection control and authentication schemes, and the support of different functions for each robot, the support of functions capable of supplementing the function limitation of the robot, etc., are needed. To this end, a robot unified platform initiative (RUPI) standard can be used. The RUPI standard is a general standard and platform that provides standard environment for a network-based robot (URC), which supports the performance of various robot services by compatibly working with various robot platforms with the server. By using the RUPI standard, compatibility between robot S/W components, various communications and interoperability with information devices, and interconnectivity with different kinds of communication networks all becomes possible.

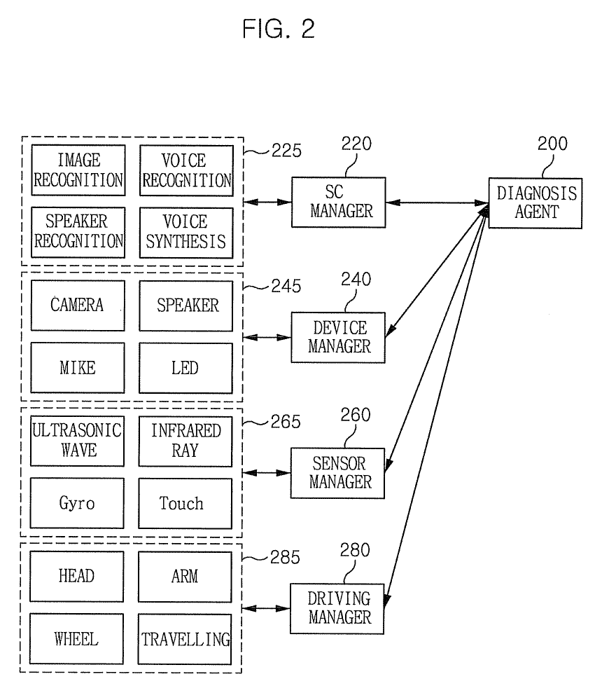

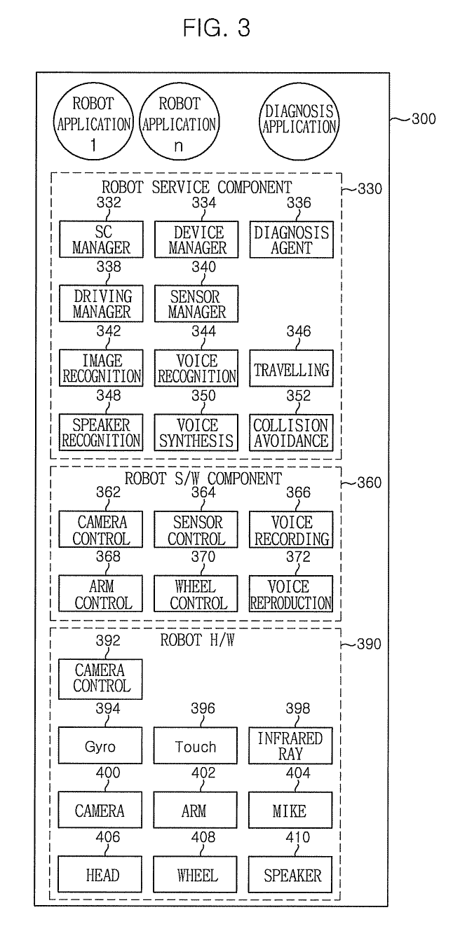

An internal configuration module of the robot, which is provided in the RUPI, is generally shown in FIGS. 2 and 3. The internal configuration module 300 of the robot is configured of a ‘robot H/W 390’, a ‘robot S/W component 360’, a ‘robot service component 330’, and a ‘module for each hierarchy of robot applications’, as shown in FIG. 3.

The ‘robot H/W 390’ is configured to include a hardware device and a driver of the robot, that is, driving devices such as a head 406, an arm 402, a wheel 408, etc., sensor devices such as an ultrasonic wave sensor 392, a Gyro (accelerator) sensor 394, a touch sensor 396, an infrared sensor 398, etc., and general devices such as a mike 404, a speaker 410, a camera 400, etc. The hardware device and the driver can be added or deleted according to the kind of robots.

The ‘robot S/W component 360’ is configured of a control module so that the robot applications and the software components can use the hardware devices of the robot, wherein the control module is bound with the devices. For example, the S/W component 360 is configured to include modules such as camera control 362, sensor control 364, arm control 368, wheel control 370, voice recording 366, voice reproduction 372, etc., as shown in the drawings. In addition, the control module can be added and deleted according to the kind of robots.

The ‘robot service component 330’ is configured to include modules 342, 344, 346, 348, 350, and 352 providing services using the ‘robot S/W components 360’ and management modules 332, 334, 336, 338, and 340 managing them. The ‘robot service component 330’ is configured to include a device manager 334, a driving manager 338, a sensor manager 340, and a software component (SC) manager 332, etc., that manage a software module providing independent services such as image recognition 342, voice recognition 344, speaker recognition 348, voice synthesis 350, travelling 346, collision avoidance 352, etc., and a configuration module of the ‘robot H/W 390’ and the ‘robot S/W component 360’. The robot applications are developed and performed by using the robot service components and the managers. For example, in order to perform the collision avoidance service 352, that is, in order to perform the applications so that the robot moves in response to sound, the robot recognizes sound through the mike 404 and uses the wheel 408 so that the robot moves. In order to process sound input through the mike 404, the robot performs voice recording 366 or determines that sound is input through the sensor control 364 and then move its wheel by the wheel control 370. The sensor control 364 or the wheel control 370 is managed by the sensor manager 340 or the driving manager 338. The services provided by the robot can be made by the hardware of the robot and the control thereof and the robot can provide services by controlling the hardware of the robot using the external server, etc., in addition to services built therein.

As shown in FIGS. 2 and 3, the robot may include diagnosis agents 200 and 336 as robot service components. As shown in FIG. 3, the diagnosis agent is operated as one of service components. As shown in FIG. 2, the diagnosis agent plays a role of collecting results on whether the failure occurs in each hardware device and the software module by transmitting query to each manager module. For example, when any failure occurs in the camera, the diagnosis agent 200 instructs the SC manager 220, the device manager 240, the sensor manager 260, and the driving manager 280 to diagnose whether the operations of each device are abnormal. As a result, the device manager 240 finds out the abnormal condition of the camera among the camera, the mike, and the LED and informs the diagnosis agent 200 of the results.

As such, the present invention is configured to include the standardized robot and the robot management server connected to the robot and may further include an external server, a terminal, and a database (DB) that are connected separately.

Hereinafter, exemplary embodiments of the present invention will be described in detail with reference to the accompanying drawings.

### First Embodiment

The robot management server 430 is configured to include a robot manager 440, robot servers 450, 460, and 470, robot objects 455, 457, 475, and 477, and a management function module 480 (connection management, authentication, diagnosis, profiling). First, when the robot is connected, the robot management server 430 determines whether the robot meets the standards (for example, RUPI standard) defined in the robot management server 430. When the robot meets the standards, the robot permits connection with the robot management server 430. The robot manager 440 generates the robot servers 450, 460, and 470 and the robot servers 450, 460, and 470 generate the robot objects 455, 457, 475, and 477 at the time when the robot is connected to the robot management server 430. The robot objects 455, 457, 475, and 477 are generated by the number of actually connected robots and are managed by the robot servers 450, 460, and 470. Each robot server 450, 460, and 470 is generated according to each kind of robot so that multi-kinds robots can be simultaneously managed by the robot management server 430. In other words, one robot server can manage only the robot of the same kind such that the functional difference, the authentication scheme, and the difference of the functional expansion included in the different kinds of robots can be processed by each robot server. Therefore, when one A kind robot is connected, the robot server and the robot object are generated one by one and when B kind of robot is further connected, the robot server and the robot object is further generated one by one. Then, when the A kind robot is further connected, the robot server for the A kind is previously generated, such that only the robot object is further generated.

The robot objects 455, 457, 475, and 477 generate the virtual components 456, 458, 476, and 478 for the ‘robot service components’ included in each actual robot and the user or the remote robot applications can be connected to the functions of the actual robot through these virtual components. For example, when the robot has the functions of the image recognition, the voice recognition, and the voice synthesis, the robot objects 455, 457, 475, and 477 have the virtual components 456, 458, 476, and 478 that can perform the functions and performs the virtual components 456, 458, 476, and 478 to actually use the functions such as the image recognition, voice recognition, voice synthesis, etc., in the robot. If the connected robot has any functions, it is stored in the robot according to a format defined by the standard, the robot processes the data, such that the robot management server 430 can know if any functions are built in the robot and allow the virtual components 456, 458, 476, and 478 to store the functions in the robot objects 455, 457, 475, and 477. The virtual components are simultaneously performed, making it possible to simultaneously control the plurality of multi-kinds robots. In addition, when functions are common to each kind of robot, the robot can simultaneously perform the functions by binding the functions.

The robot objects 455, 457, 475, and 477 are generated at the time when authentication is succeeded by the connection of the robot and deleted when the access is released. Herein, the robot servers 450, 460, and 470, from which all the robot objects 455, 457, 475, and 477 are deleted, are not deleted from the memory and can wait for the connection of the robot. Thereby, when the robot of the kind corresponding to the robot server, from which all the robot objects are deleted, is connected again, there is no need to generate the robot servers again.

The robot manager 440 generates the robot servers 450, 460, and 470 and provides the search functions. The management function module 480 has ‘connection management 482’, ‘authentication 484’, ‘diagnosis 486’, ‘functional expansion (profiling) 488’, etc. These modules are shared and used by the robot servers 450, 460, and 470 and when the robot management server 430 starts, these modules are generated and responds to the request from the robot servers 450, 460, and 470.

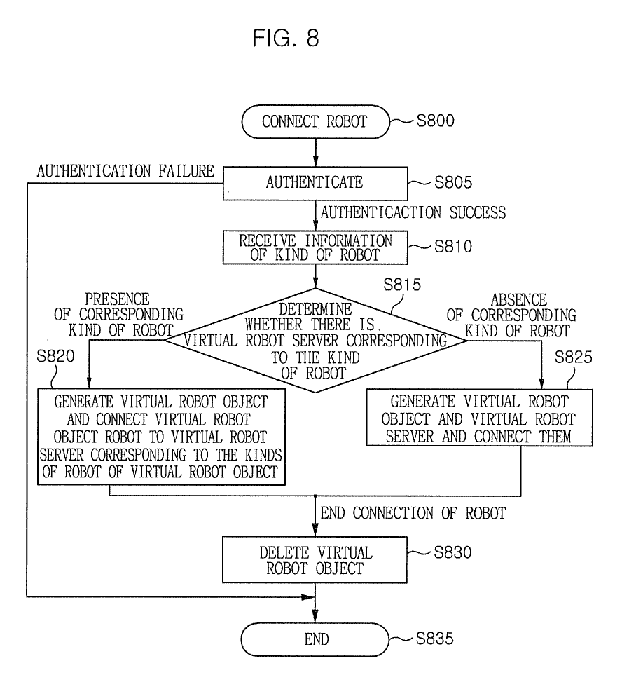

In the present invention, a process from a point in time when the robot is connected to a point in time when the robot is disconnected will be described below with reference to FIG. 8. First, when the robot is connected (S800), the management function module of the robot management server authenticates whether the robot meets the standards and if not, ends the connection of the robot and if so, the authentication is succeeded (S805). If the authentication is succeeded, the robot management server receives the information of the kind of robot from the robot (S810). Thereafter, it is determined whether the virtual robot server corresponding to the kind of robot connected to the robot management server is already generated based on the received information (S815). When the virtual robot server of the corresponding kind is generated, the virtual robot object corresponding to the connected robot is generated and the generated virtual robot object connects to the virtual robot servers that are already generated (S820). When the virtual robot server of the corresponding kind is not generated, the virtual robot object corresponding to the connected robot is generated, the virtual robot server corresponding to the kind of connected robot is generated, and then, the generated virtual robot object connects to the generated virtual robot server (S825). Thereafter, when the connection of the robot ends, the virtual robot object is deleted (S830).

Through the above configuration, the present embodiment overcomes the functional limitation due to the different kinds of robots, thus the plurality of robots can be simultaneously managed by one server.

### Second Embodiment

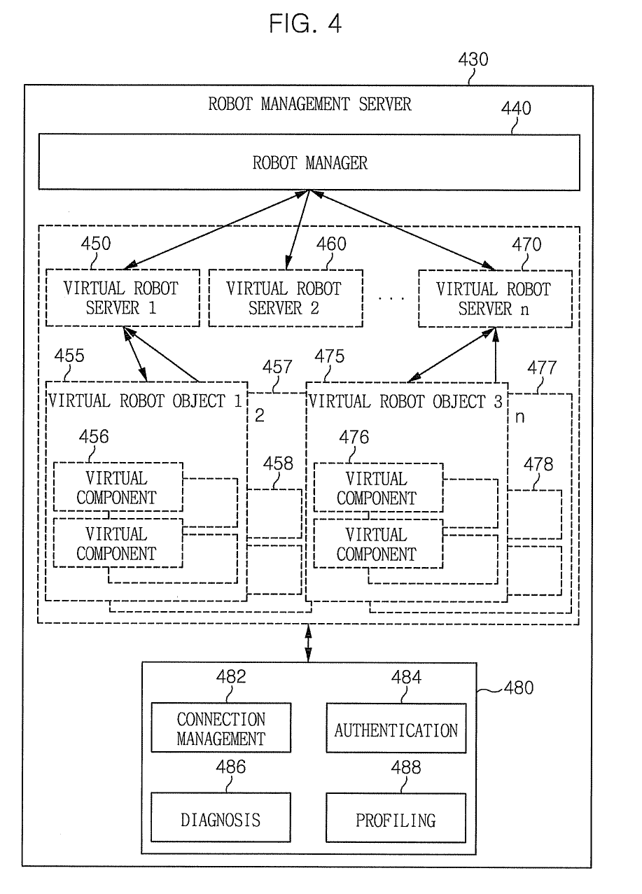

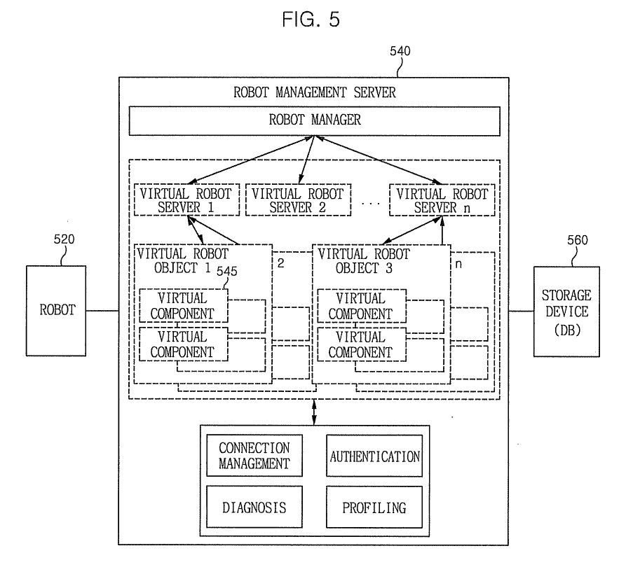

FIG. 5 is a diagram showing a second embodiment and is a diagram showing a shape where the robot management server proposed in the first embodiment is connected to the robot. First, when a robot 520 is connected, a robot manager of a robot management server 540 determines whether the robot meets the standards defined in the robot management server 540. When the authentication process is performed and then the connection is completed, the robot manager reads the information of the kind of connected robot 520 and then, generates the robot server according to the kinds. When the same kind of the robot server is already generated, the robot server is not separately generated. Thereafter, after the robot server generates the robot object and reads the functional information of the robot, it generates the robot object including the virtual component. As such, the reason why the kind of robot and the functional information of the robot can be read is that the robot stores information based on standardization. The second embodiment differs from the first embodiment in that the robot management server may additionally have components in addition to the components built in the robot. For example, the robot 520 does not have the voice synthesizing function and may have only the mike and the speaker. In this case, the robot 520 transmits the data input through the mike to the robot management server 540 and the virtual component 545 in the robot management server 540 uses the input data to perform the voice synthesis process. Thereafter, the processed data is transmitted to the robot 520 and the robot 520 can output the synthesized data through the speaker. Through the above processes, the robot 520 may have the voice synthesis function without requiring a separate voice synthesis apparatus, such that miniaturization of the robot can be achieved and the function of the robot can be expanded. The virtual component 545 of the second embodiment differs from the virtual components 456, 458, 476, and 478 of FIG. 4 of the first embodiment in that the detailed contents of the component are implemented in the robot management server 540, not the robot 520. However, the second embodiment is the same as the first embodiment in that the functions of the robot are performed within the virtual robot object connected to the virtual robot server and therefore, their names are referred to as the virtual component like the first embodiment.

The additional function of the above-mentioned virtual component 545 may be added after the robot 520 is connected to the robot management server 540 and the functions of other kinds of robots can also be used when the different kinds of robots are compatible. In addition, the robot management server 540 may be provided with a separate storage device 560. In other words, the robot 520 transmits the information to be stored to the robot management server 540 at any time and the transmitted information is stored in the storage device 560 connected to the robot management server 540. Thereafter, the robot 520 can access the storage device of the robot management server 540 to receive necessary information.

### Third Embodiment

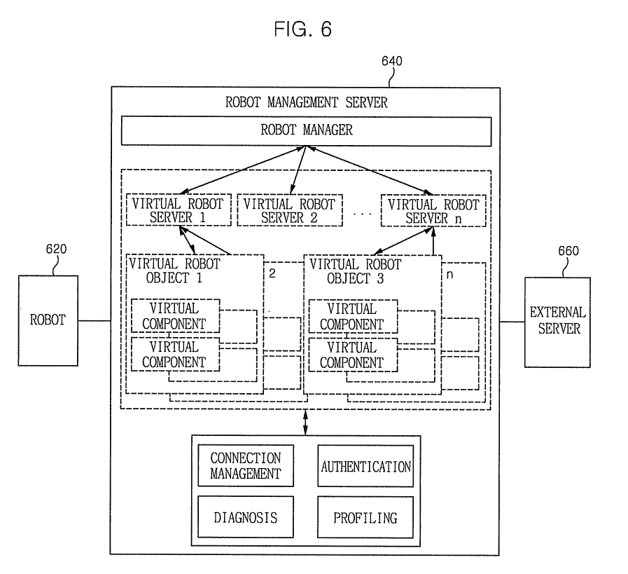

FIG. 6 is a diagram showing a third embodiment, wherein the robot management server proposed in the first embodiment is connected to the robot and connected to a separate external server 660. First, when a robot 620 is connected, a robot manager of a robot management server 640 determines whether the robot meets the standards defined in the robot management server 640. When several standards can be compatible and the robot management server 640 includes the compatible function, robot management server can include a plurality of standards.

When the authentication process is performed and then the connection is completed, the robot manager reads the information of the kind of connected robot 620 and then, generates the robot server according to the kind. When the same kind of robot server is already generated, the robot server is not separately generated. Thereafter, after the robot server generates the robot object and reads the functional information of the robot, it generates the robot object including the virtual component. As such, the reason why the kind of robots and the functional information of the robot can be read is that the robot stores information due to the standardization. The third embodiment differs from the first embodiment in that the robot management server may additionally have components in addition to the components built in the robot and differs from the second embodiment in that the robot management server is connected to the external server 660. As described in the second embodiment, the robot 620 can use the voice synthesis function by the robot management server 640 without requiring the voice synthesis function. In other words, the second embodiment expands the function of the robot by including, functions, which are not included in the robot, in the robot management server, whereas in the third embodiment, the separate server 660 includes the functions of the robot. In other words, when the robot 620 needs the voice synthesis function, the robot management server 640 is connected to the external server 660 having the voice synthesis function. Thereafter, the robot 620 transmits the voice data to the robot management server 640, the robot management server 640 transmits the data to the external server 660, the external server 660 processes the received voice data and then transmits the processed data to the robot management server 640 again. Thereafter, the robot management server 640 transmits the processed data to the robot 640 again. Through the above configuration, when the expanding function of the robot 620 is needed, the robot management server 640 is enough to connect to the external server 660 including the necessary functions, making it possible to very conveniently expand the functions of the robot.

### Fourth Embodiment

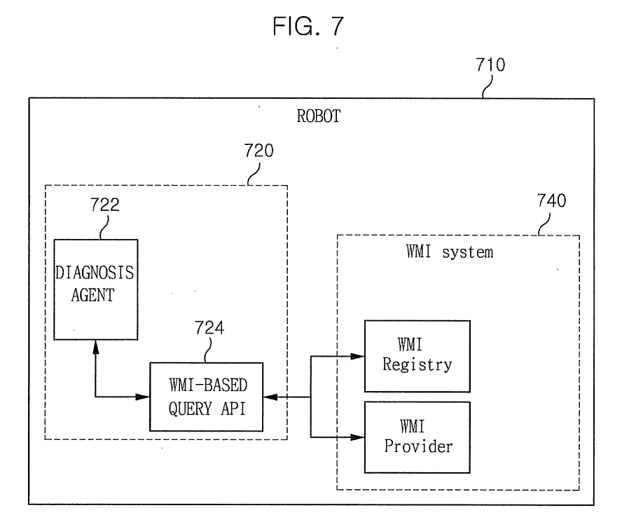

FIG. 7 is a diagram showing a structure of a robot resource diagnosis according to the present invention, in particular, a diagram showing a structure of a module used for querying a system resource in a robot.

In other words, the robot may include a diagnosis module that diagnoses the devices inside the robot.

The diagnosis function monitors the state of the robot to generate information on whether the robot is normally operating and then reports it to the manager. To this end, operating information on a system internal hardware device, a hardware driver module, a software component, a software module, etc., should be brought. A window operating system uses a windows management instrumentation (WMI) function to bring static information and dynamic operating information on all the hardware devices and software modules that are operated in Windows. The diagnosis agent compatibly works with the WMI API to use the function such that it extracts information on malfunction, errors, etc., of the robot in real time when the operating system of the robot is performed by the window operating system and transmits the extracted information to a remote place, thereby making it possible for the manager to monitor the state of the robot.

In other words, a diagnosis agent 722 issues diagnosis instructions through WMI-based query API 724 when it needs resource information of the robot, and the WMI-based query API 724 receives the diagnosis results through a WMI system 740. Thereafter, the received information is transmitted to the diagnosis agent 722. The resource information may be stored in the separate database and the terminal at a remote place can access the database to query the resource information. Although the fourth embodiment describes configuration of the robot based on WINDOWS that is an operating system from MICROSOFT Co., the robot can be configured of other operating systems such as Linux, Unix, etc.

The present invention can be implemented as a computer-readable code in a computer-readable recording medium. The computer-readable recording media includes all types of recording apparatuses in which data readable by a computer system is stored. Examples of the computer-readable recording media may include a ROM, a RAM, a CD-ROM, a magnetic tape, a floppy disk, an optical data storage, etc. In addition, the computer-readable recording media also include one implemented in the form of a carrier wave (i.e., transmission through the Internet). Further, the computer-readable recording media are distributed on systems connected over the network, and are stored and executed as the computer-readable code by a distribution method.

As described above, the exemplary embodiments have been described and illustrated in the drawings and the description. Herein, specific terms have been used, but are just used for the purpose of describing the present invention and are not used for qualifying the meaning or limiting the scope of the present invention, which is disclosed in the appended claims. Therefore, it will be appreciated to those skilled in the art that various modifications are made and other equivalent embodiments are available. Accordingly, the actual technical protection scope of the present invention must be determined by the spirit of the appended claims.

What is claimed is:

1. A robot management server connected to a plurality of robots by a network, comprising:
a robot manager that generates or deletes virtual robot servers;
a management function module that performs at least one of connection management, authentication, diagnosis, and profiling on the connected robots;
the virtual robot servers that are generated by the robot manager and the number of the virtual robot servers generated equal to the number of kinds of connected robots; and
virtual robot objects that are generated by the number of connected robots and are each connected to the virtual robot servers corresponding to the kinds of robot of the virtual robot objects.

2. The robot management server according to claim 1, wherein the robot manager:
when a new robot is connected, determines whether there is a virtual robot server corresponding to a kind of newly connected robot among the generated virtual robot servers;
if it is determined that there is the corresponding virtual robot server, generates a virtual robot object for the newly connected robot and connects it to the corresponding virtual robot server; and
if it is determined that there is no corresponding virtual robot server, generates the virtual robot object for the newly connected robot and the virtual robot server for the kind of newly connected robot, and connects the virtual robot object to the virtual robot server.

3. The robot management server according to claim 1, wherein the virtual robot server generates the virtual robot objects when the robot is connected and deletes the virtual robot objects when the robot is disconnected.

4. The robot management server according to claim 1, wherein the virtual robot object includes at least one virtual component for accessing the functions of the robot.

5. The robot management server according to claim 1, wherein the virtual robot object includes at least one virtual component that performs additional functions in addition to functions installed in the robot.

6. The robot management server according to claim 1, wherein the robot management server is connected to the external server and the external server provides the robot function.

7. The robot management server according to claim 1, wherein the robot management server receives diagnosis results of a state diagnosis module that is included in the robot diagnosing the malfunction or failure of the robot.

8. The robot management server according to claim 7, wherein the receiving data of the robot management server are queried through a terminal connected to the network.

9. The robot management server according to claim 1, wherein the robot is standardized by using an RUPI standard.

10. The robot management server according to claim 1, wherein the robot management server is connected to the robot in a wired or wireless scheme.
